(19) United States
(12) Patent Application Publication
(10) Pub. No.: US 2015/0376045 A1
(43) Pub. Date: Dec. 31, 2015

(54) APPARATUS AND METHOD FOR TREATING SLUDGE

(71) Applicant: SAC CO., LTD., Asan-si Chungcheongnam-do (KR)

(72) Inventors: Hae Jin LEE, Cheonan-si (KR); Don Oh HAM, Cheonan-si (KR); Gyeong Hoon JO, Buk-gu (KR)

(21) Appl. No.: 14/766,604

(22) PCT Filed: Sep. 16, 2013
(86) PCT No.: PCT/KR2013/008335

§ 371 Date: Aug. 7, 2015

(30) Foreign Application Priority Data
Feb. 8, 2013 (KR) 10-2013-0014286
Feb. 8, 2013 (KR) 10-2013-0014288

(51) Int. Cl. C02F 11/18; F23G 5/44; F23G 5/04; C02F 11/12; F26B 21/12

(52) U.S. Cl. CPC C02F 11/18; C02F 11/12; F26B 21/12; F23G 5/04; F23G 5/442; C02F 2209/02; C02F 2209/38

(57) ABSTRACT

A sludge treating apparatus includes a drying unit drying water purification sludge of a high moisture content, a burning unit burning the water purification sludge dried in the drying unit, and a transfer unit transferring the water purification sludge from the drying unit into the burning unit, wherein the drying unit includes a hollow drying tank in which the water purification sludge is charged, and which dries the water purification sludge by dry air, an air supply member heating the dry air such that an amount of saturated vapor of the dry air increases, to supply the heated dry air into the drying tank, and a control unit measuring temperature, humidity, and weight of the drying tank to control a temperature and a flow rate of the heated dry air that is supplied from the air supply member into the drying tank.

### CROSS-REFERENCE TO RELATED APPLICATIONS

This U.S. non-provisional patent application claims priority under 35 U.S.C. §119 of Korean Patent Application Nos. 10-2013-0014286, filed on Feb. 08, 2013, and 10-2013-0014288, filed on Feb. 08, 2013, the entire contents of which are hereby incorporated by reference.

### BACKGROUND OF THE INVENTION

The present invention disclosed herein relates to an apparatus and a method for treating sludge.

Generally, sludge that is sediment generated during a sewage treatment or water purification is called as waste products. Since sludge water purification contains moisture not less than about 80%, it is difficult to treat the sludge.

Thus, so far, the sludge is treated using a method in which the sludge is stabilized by an anaerobic treatment is then demoistured and buried. However, since such a treatment method using the anaerobic treatment is difficult to treat the increased sludge according to the recent advancements in industries rapidly accelerated, there have been many studies.

In recent, there are a technology that decreases moisture of the sludge by directly supplying hot air or cold air having a low moisture content into an apparatus in which the sludge is stored, and a sludge drying apparatus in which sludge is made to a high temperature state by supplying high temperature heat into the sludge water purification so that moisture included in the sludge is evaporated to decrease a weight and volume of the sludge, thereby decreasing moisture content of the sludge.

However, since the typical sludge drying apparatus reduces moisture included in sludge by contacting hot air having a temperature of about 800° C. or more with the sludge by using a heating dry method (a rotary kiln, disk), energy costs are increased two times or more to dry the moisture within the sludge in comparison with a disposal discharging sludge into the sea, and also, high costs should be paid as the equipment cost of post-treatment facilities for preventing air pollution due to generation of waste gas such as NOx.

Also, in the typical sludge drying apparatus, no matter how a temperature of the sludge drying apparatus is increased so as to increase a heat transfer rate during a heat dry process of the sludge, since outer sludge first absorbs all heat energy to evaporate moisture, a heat transfer blocking in which heat energy supply into an inside of the sludge that is required for evaporation of moisture is blocked may occur. Since the sludge is sequentially dried starting from a surface thereof by the heat transfer blocking, the heat energy supply that is required for drying the inside of the sludge is blocked.

Like that, the typical sludge drying apparatus may have limitation in that drying rate and drying velocity are low in comparison with an amount of heat applied.

While sewage sludge is recycled as agricultural organic raw materials, since the water purification sludge has organic content less than that of the sewage sludge, it is difficult to use the water purification sludge as the agricultural organic raw materials such as fertilizers, and the like. For this reason, studies and attempts to apply the water purification sludge to construction earthmoving materials or materials of ceramic or brick, and the like by using nature in which a main inorganic component of the water purification sludge is clay-like in classification of soil, and the main of the water purification sludge is inorganic component have been tried.

Since the water purification sludge contains high inorganic materials, the water purification sludge is hardened like a metal at a temperature of about 1000° C. or more. For this reason, in a case where the water purification sludge is performed in the same process as a typical sewage sludge treatment process, products hardened after treating the water purification sludge should be pulverized through a separate pulverization process. Also, the water purification sludge is characterized by having less odor than sewage sludge and that it is easy to reduce moisture content.

The typical sludge treating apparatus is designed and manufactured so as to treat all of the sewage sludge and water purification sludge (or, water purification sludge) while ignoring characteristic differences between the water purification sludge and the sewage sludgewater purification water purification. Thus, in the treatment of the water purification sludge, the typical sludge treating apparatus may increase manufacturing costs and reduce cost-effectiveness due to the addition of unnecessary processes.

### SUMMARY OF THE INVENTION

The present invention provides a sludge treating apparatus that may reduce sludge using low energy.

The present invention also provides a sludge treating apparatus that is used to optimize the drying of sludge and simultaneously reduces content within sludge at the same time, thereby reducing energy consumption.

The present invention also provides a sludge treating apparatus that may dry sludge using an amount of saturated water vapor of air.

The feature of the present invention is not limited to the aforesaid, but other features not described herein will be clearly understood by those skilled in the art from descriptions below.

Embodiments of the present invention provide sludge treating apparatuses including: a drying unit drying water purification sludge of a high moisture content; a burning unit burning the water purification sludge dried in the drying unit; and a transfer unit transferring the water purification sludge from the drying unit into the burning unit, wherein the drying unit includes: a hollow drying tank in which the water purification sludge is charged, and which dries the water purification sludge by dry air; an air supply member heating the dry air such that an amount of saturated vapor of the dry air increases, to supply the heated dry air into the drying tank; and a control unit measuring temperature, humidity, and weight of the drying tank to control a temperature and a flow rate of the heated dry air that is supplied from the air supply member into the drying tank such that evaporation by the dry air in the drying tank is optimized.

In some embodiments, the drying unit may further include a load cell sensing a change in weight of the water purification sludge that is charged in the drying tank, wherein the control unit may obtain a drying curve from the change in weight of the water purification sludge that is provided from the load cell to control the temperature and the flow rate of the dry air that is supplied into the drying tank according to a slope of the drying curve.

In other embodiments, the drying unit may further include a sludge measuring unit checking a temperature and humidity of the water purification sludge charged in the drying tank to provide the checked temperature and humidity to the control unit, wherein the control unit may control the air supply member in order to maintain the water purification sludge at a temperature of about 90° C. to about 99° C.

In still other embodiments, the drying unit may further include: an air supply line measuring unit checking a temperature and humidity of the dry air supplied into the drying tank; and an air discharge line measuring unit checking a temperature and humidity of the dry air discharged from the drying tank, wherein the control unit may compare the temperature and humidity of the dry air checked by the air supply line measuring unit with the temperature and humidity of the dry air checked by the air discharge line measuring unit to calculate an amount of moisture desorbed from the water purification sludge, thereby controlling the air supply member.

In even other embodiments, the sludge treating apparatus may further include a waste heat processing unit maintaining a temperature of the drying tank by using waste heat of the burning unit.

In yet other embodiments, the drying tank may include: an inner container in which the water purification sludge is charged; and an outer container surrounding the inner container, wherein a heat-exchange space in which the waste heat provided from the waste heat treating is supplied may be defined between the inner container and the outer container.

In further embodiments, the burning unit may include: a burning chamber; a cylindrical chamber rotatably installed in the burning chamber, and having a transfer screw provided therein; and heaters installed adjacent to the cylindrical chamber in the burning chamber.

In other embodiments of the present invention, sludge treating methods including: drying a water purification sludge of a high moisture content; and burning the dried water purification sludge, wherein, in the drying of the water purification sludge, dry air having a temperature of about 100° C. or less is supplied into an inner container of a drying tank in which the water purification sludge is charged to remove moisture of the water purification sludge by evaporation through the dry air.

In some embodiments, the drying of the water purification sludge may further include optimizing the evaporation through the dry air in the drying tank.

In other embodiments, in the optimizing of the evaporation, a change in weight of the water purification sludge that is charged in the drying tank may be measured to obtain a drying curve of the water purification sludge, and a slope of a predetermined drying curve may be compared to a slope of the obtained drying curve to control a flow rate of the dry air that is supplied into the drying tank.

In still other embodiments, in the drying of the water purification sludge, when the water purification sludge charged in the drying tank may have a temperate lower than a predetermined temperature, the drying tank may be preheated using waste heat that is generated in the burning of the water purification sludge.

In even other embodiments in the drying of the water purification sludge, the water purification sludge may be maintained at a temperature of about 90° C. to about 99° C.

In yet other in the drying of the water purification sludge, temperature and humidity of the dry air supplied into the drying tank and temperature and humidity of the dry air discharged from the drying tank may be checked and compared to calculate an amount of moisture desorbed from the water purification sludge, thereby controlling a flow rate of the dry air that is supplied into the drying tank.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view of a water purification sludge treating apparatus according to an embodiment of the present invention; and

FIG. 2 is a graph showing a drying curve of optimized sludge.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a water purification sludge treating apparatus according to exemplary embodiments of the present invention will be described in detail with reference to the accompanying drawings.

In description of the present invention, detailed descriptions related to well-known functions or configurations will be ruled out in order not to unnecessarily obscure subject matters of the present invention.

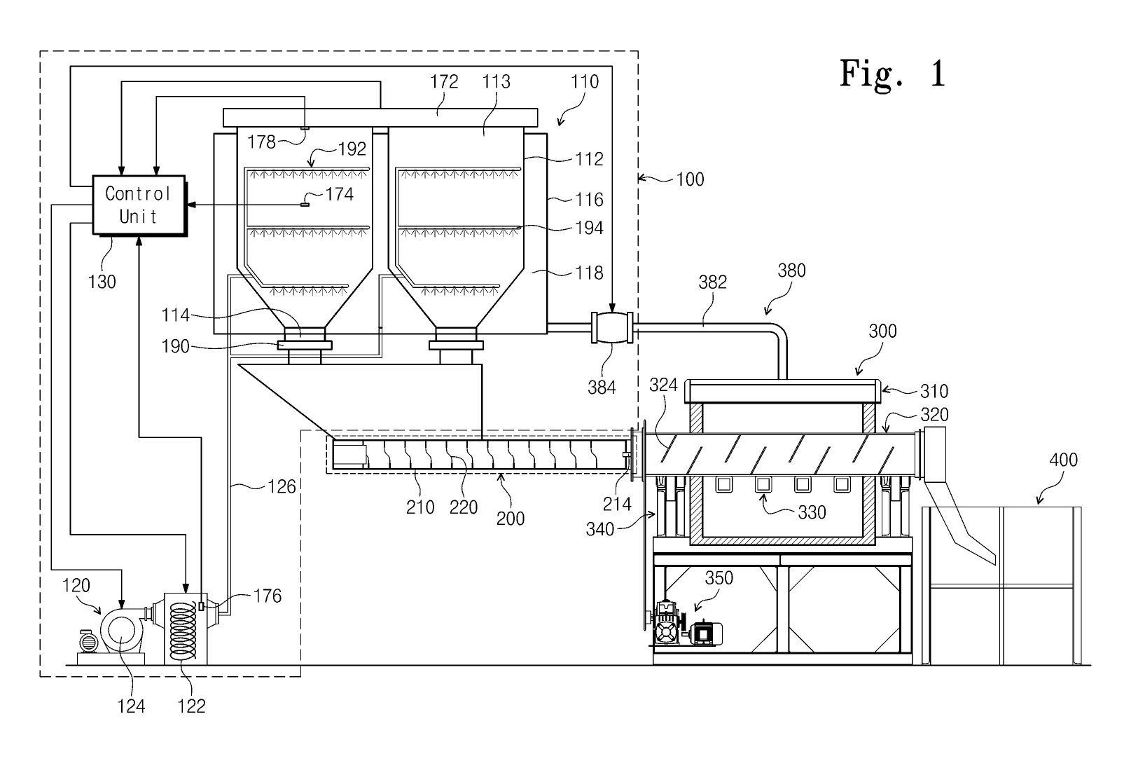

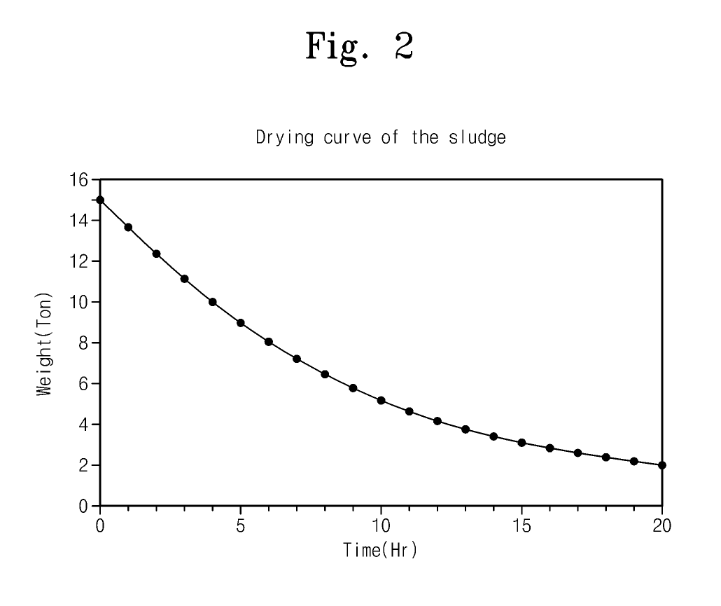

FIG. 1 is a view of a water purification sludge treating apparatus according to an embodiment of the present invention. FIG. 2 is a graph showing a drying curve of optimized sludge.

Referring to FIG. 1, a water purification sludge treating apparatus 10 may include a drying unit 100, a transfer unit 200, and a burning unit 300.

The drying unit 100 forcibly dries water purification sludge that has a high moisture content (about 70% to about 80%) and is difficult to dry, by using dry air of about 100° C. or less such that the moisture content finally becomes about 12% to about 18%. For example, the drying unit 100 removes moisture of the water purification sludge by using dry air of about 90° C. to about 99° C.

The water purification sludge treating apparatus according to the present invention may be a low energy consumption type drying apparatus in that a temperature of air used in sludge drying is not above about 99° C., compared with a typical drying apparatus which mainly uses heat having a temperature of about 200° C. or more.

The drying unit 100 may include a drying tank 110, an air supply member 120, and a control unit 130.

The drying tank 110 may include an inner container 112 and an outer container 116.

The inner container 112 may have an inner space 113 in which the water purification sludge is charged. The inner container 112 has a charging hole which is formed in an opened state in an upper portion thereof and through which the water purification sludge is introduced. Also, the inner container 112 has a discharge hole 114 formed in a lower portion thereof. The discharge hole 114 may be opened or closed by an opening/closing unit 190. The discharge hole 114 is connected to an end of the transfer unit 200. When the discharge hole 114 is opened, the water purification sludge drops into the transfer unit 200.

A plurality of air blowing units 192 connected to a tube 126 is disposed in the inner container 112 of the drying tank 110. The air blowing units 192 include blowing nozzle tubes 194 having a plurality of blowing holes to uniformly supply dry air into the water purification sludge that is charged in the inner container 112 of the drying tank 110. For example, the dry air is blown downward through the blowing holes defined in the blowing nozzle tubes 194 so that the blowing holes are not blocked by the water purification sludge. The water purification sludge is dried by a relative humidity and a saturated steam pressure difference by blowing dry air having a temperature of about 99° C. to about 99° C. through the blowing nozzle tube 194 into the drying tank 110.

The outer container 116 surrounds the inner container 112. A heat-exchange space 118 is defined between the outer container 116 and the inner container 112 to supply waste heat provided from a waste heat processing unit 380 of the burning unit 300.

The air supply member 120 heats the dry air in order to increase an amount of saturated vapor of the dry air, and supplies the dry air heated into the drying tank 110. The air supply member 120 may include a heater 122 and a blower 124. While various types of heaters may be used, the heater 122 may be, for example, a heater using an electrical resistance heat generating coil.

The air supplied into the heater 122 through the blower 124 is heated at a temperature suitable for drying the water purification sludge, and then is supplied into the inner container 112 of the drying tank 110. For example, the air may be heated at a temperature of about 90° C. to about 99° C. or less. The air supply member 120 is connected to the drying tank 110 by the tube 126, and the dry air discharged from the inner container 112 is supplied into the drying tank 110 through the tube 126.

The control unit 130 controls a temperature and a flow rate of the heated dry air that is supplied into the drying tank 110 in order to optimize evaporation by the dry air in the drying tank 110.

The transfer unit 200 may be provided in a screw conveyer shape in which a cylindrical casing 210 is connected to a transfer screw 220.

The cylindrical casing 210 is installed in parallel to the ground, and has a first opening which is formed in one end thereof and through which the water purification sludge is introduced from the discharge hole 114 of the drying unit 100, and a second opening which is formed in the other end thereof and through which the water purification sludge is discharged. The second opening is connected to a burning chamber 310 of the burning unit 300.

The transfer screw 220 has a screw type disk shape, and is installed in the cylindrical casing 210. The transfer screw 220 is manufactured so as to be rotatable by driving means such as a motor. The transfer screw 220 may be manufactured with a spacing that is as narrow as possible between a circumference of the disc of the transfer screw 220 and an inner surface of the cylindrical casing 210 such that the introduced water purification sludge may be transferred toward the second opening without loss.

The burning unit 300 may include the burning chamber 310, a cylindrical chamber 320, a burning heater 330, and a waste heat processing unit 380.

The cylindrical chamber 320 coupled with a transfer screw 324 is installed in the forming chamber 310. The transfer screw 324 may be provided on an inner surface of the cylindrical chamber 320. The cylindrical chamber 320 has a first opening which is formed in one end thereof and through which the water purification sludge is introduced from the transfer unit 200, and a second opening which is formed in other end thereof and through which the water purification sludge is discharged.

Both ends of the cylindrical chamber 320 are rotatably supported by a support bearing 340. The cylindrical chamber 320 is connected to a rotation drive device 350 to rotate. The cylindrical chamber 320 may be formed of a metal or an alloy having a high melting point that is higher than a burning temperature of the water purification sludge. The burning temperature may be in a range from about 500° C. to about 1000° C. When the burning temperate is less than about 500° C., the burning may not be sufficient, and when the burning temperate exceeds about 1,000° C., energy may be wasted.

The burning heaters 330 are disposed adjacent to a lower end of the cylindrical chamber 320. The burning heaters 330 may include electric heating furnace type heaters.

The water purification sludge put into the cylindrical chamber 320 is burned by the burning heaters 330 while passing through the cylindrical chamber 320, and then discharged water purification to a yard 400.

The waste heat processing unit 380 maintains the temperature of the drying tank by using the waste heat of the burning unit 300. The waste heat processing unit 380 includes a waste heat supply line 382 of which one end is connected to the burning chamber 310, and the other end is connected to the drying tank 110. An opening/closing valve 384 is installed on the waste heat supply line 382.

Again referring to FIG. 1, the drying unit 100 includes a load cell 172, a sludge measuring unit 174, an air supply line measuring unit 176, and an air discharge line measuring unit 178.

The load cell 172 is disposed to sense a change in weight of the water purification sludge that is charged in the inner container 112 of the drying tank 110 in real-time or at a predetermined time interval. The load cell 172 provides the sensed weight of the water purification sludge to the control unit 130.

The control unit 130 obtains a drying curve of the water purification sludge using a change in weight of the water purification sludge that is provided from the load cell 172 to control a temperature and a flow rate of the dry air that are supplied into the drying unit 100 according to a slope of the drying curve.

The drying curve of the sludge is shown in FIG. 2. In an example, the control unit 130 compares a slope of the obtained drying curve with a slope of a predetermined drying curve (optimized drying curve). When the slope of the obtained drying curve is greater than that of the predetermined drying curve, the control unit 130 determines that a dry amount with respect to time is excessive and decreases the temperature or flow rate of the dry air to reduce excessive energy consumption. Also, when the slop of the calculated drying curve is less than that of the predetermined drying curve, the control unit 130 determines that the dry amount with respect to time is insufficient and increases the temperature or the flow rate of the dry air to control a target amount of the dry air.

The sludge measuring unit 174 checks a temperature and humidity of the water purification sludge charged in the inner container 112 of the drying tank, and provides the checked temperature and humidity to the control unit 130.

The control unit 130 controls the air supply member 120 and the waste heat processing unit 380 in order to maintain the water purification sludge at a temperature of about 90° C. to about 99° C. For example, when the temperature of the water purification sludge is lower than a predetermined temperature (for example, about 95° C.), the control unit 130 controls the air supply member 120 to increase the temperature of the dry air thereof, or controls the waste heat processing unit 380 to be opened such that waste heat is supplied into the heat-exchange space 118 of the drying tank 110 to auxiliary increase the temperature of the inner container 112, thus compensating for the temperature of the water purification sludge. On the contrary, when the temperature of the water purification sludge is higher than the predetermined temperature (for example, about 95° C.), the control unit 130 controls the air supply member 120 to decrease the temperature of the dry air of the air supply member 120 or to bloke the supply of waste heat into the heat-exchange space 118, thus decreasing the temperature of the water purification sludge.

The air supply line measuring unit 176 checks a temperature and humidity of dry air supplied into the drying tank 110, and the air discharge line measuring unit 178 checks the temperature and humidity of the dry air discharged from the drying tank 110. The checked temperature and humidity of the dry air are provided to the control unit 130.

The control unit 130 compare the temperature and humidity measured by the air supply line measuring unit 176 with the temperature and humidity measured by the air discharge line measuring unit 178 to calculate an amount of moisture desorbed from water purification sludge, thereby controlling the flow rate of the dry air of the air supply member 120 according to the amount of the desorbed moisture.

The present invention calculates an amount of moisture which is evaporated from the water purification sludge by the dry air on the basis of a temperature and humidity of the air discharged from the drying tank 110, and may anticipate and adjust a target desorption amount of moisture by controlling a necessary dry amount on the basis of flow rate of supply and discharge, temperature, and humidity.

Although not illustrated in the drawings, the drying unit 100 may further include a dehumidification unit. The dehumidification unit is installed between the blower 124 and the heater 122 of the air supply member 120 to remove moisture in air provided to the heater 122 and provide the moisture-removed air to the heater 122. The dehumidification unit may have any structure commonly used in the art, but is not limited to a specific structure. For example, the dehumidification unit may have a porous pellet structure or a structure in which moisture particles in the air passing through an inner hole or space are adsorbed in order to separate the air and the moisture.

The method and apparatus for treating sludge described above may be employed in not only the water purification sludge but also the sewage sludge treatment. In the case of the sewage sludge treatment, a burning temperature may be in a range of about 300° C. to about 400° C.

According to the embodiments of the present disclosure, the water of the sludge having the high moisture content may be reduced through only using the dry air without boiling, thereby reducing operating expenses.

According to the embodiments of the present disclosure, equipment operating costs may decrease by using the waste heat.

According to the embodiments of the present disclosure, the target desorption amount of the moisture may be anticipated and adjusted.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. The scope of protection of the present disclosure, all the technical idea, within the scope of its equivalent shall be construed by the following claims should be construed as being included in the scope of the present disclosure.

What is claimed is:

1. A sludge treating apparatus comprising:
a drying unit drying water purification sludge of a high moisture content;
a burning unit burning the water purification sludge dried in the drying unit; and
a transfer unit transferring the water purification sludge from the drying unit into the burning unit,
wherein the drying unit comprises:
a hollow drying tank in which the water purification sludge is charged, and which dries the water purification sludge by dry air;
an air supply member heating the dry air such that an amount of saturated vapor of the dry air increases, to supply the heated dry air into the drying tank; and
a control unit measuring temperature, humidity, and weight of the drying tank to control a temperature and a flow rate of the heated dry air that is supplied from the air supply member into the drying tank such that evaporation by the dry air in the drying tank is optimized.

2. The sludge treating apparatus of claim 1, wherein the drying unit further comprises a load cell sensing a change in weight of the water purification sludge that is charged in the drying tank,
wherein the control unit obtains a drying curve from the change in weight of the water purification sludge that is provided from the load cell to control the temperature and the flow rate of the dry air that is supplied into the drying tank according to a slope of the drying curve.

3. The sludge treating apparatus of claim 1, wherein the drying unit further comprises a sludge measuring unit checking a temperature and humidity of the water purification sludge charged in the drying tank to provide the checked temperature and humidity to the control unit,
wherein the control unit controls the air supply member in order to maintain the water purification sludge at a temperature of about 90° C. to about 99° C.

4. The sludge treating apparatus of claim 1, wherein the drying unit further comprises:
an air supply line measuring unit checking a temperature and humidity of the dry air supplied into the drying tank; and
an air discharge line measuring unit checking a temperature and humidity of the dry air discharged from the drying tank,
wherein the control unit compares the temperature and humidity of the dry air checked by the air supply line measuring unit with the temperature and humidity of the dry air checked by the air discharge line measuring unit to calculate an amount of moisture desorbed from the water purification sludge, thereby controlling the air supply member.

5. The sludge treating apparatus of claim 1, further comprising a waste heat processing unit maintaining a temperature of the drying tank by using waste heat of the burning unit.

6. The sludge treating apparatus of claim 5, wherein the drying tank comprises:
an inner container in which the water purification sludge is charged; and
an outer container surrounding the inner container,
wherein a heat-exchange space in which the waste heat provided from the waste heat processing unit is supplied is defined between the inner container and the outer container.

7. The sludge treating apparatus of claim 1, wherein the burning unit comprises:
a burning chamber;
a cylindrical chamber rotatably installed in the burning chamber, and having a transfer screw provided therein; and
heaters installed adjacent to the cylindrical chamber in the burning chamber.

8. A sludge treating method comprising:
drying a water purification sludge of a high moisture content; and
burning the dried water purification sludge,
wherein, in the drying of the water purification sludge, dry air having a temperature of about 100° C. or less is supplied into an inner container of a drying tank in which the water purification sludge is charged to remove moisture of the water purification sludge by evaporation through the dry air.

9. The sludge treating method of claim 8, wherein the drying of the water purification sludge further comprises optimizing the evaporation through the dry air in the drying tank.

10. The sludge treating method of claim 9, wherein, in the optimizing of the evaporation, a change in weight of the water purification sludge that is charged in the drying tank is measured to obtain a drying curve of the water purification sludge, and a slope of a predetermined drying curve is compared to a slope of the obtained drying curve to control a flow rate of the dry air that is supplied into the drying tank.

11. The sludge treating method of claim 8, wherein, in the drying of the water purification sludge, when the water purification sludge charged in the drying tank has a temperate lower than a predetermined temperature, the drying tank is preheated using waste heat that is generated in the burning of the water purification sludge.

12. The sludge treating method of claim 11, wherein, in the drying of the water purification sludge, the water purification sludge is maintained at a temperature of about 90° C. to about 99° C.

13. The sludge treating method of claim 8, wherein, in the drying of the water purification sludge, temperature and humidity of the dry air supplied into the drying tank and temperature and humidity of the dry air discharged from the drying tank are checked and compared to calculate an amount of moisture desorbed from the water purification sludge, thereby controlling a flow rate of the dry air that is supplied into the drying tank.
